(19) United States
(12) Patent Application Publication
(10) Pub. No.: US 2023/0100030 A1
(43) Pub. Date: Mar. 30, 2023

(54) LITHIUM ION BATTERY

(71) Applicant: Panasonic Intellectual Property Management Co., Ltd., Osaka-shi, Osaka (JP)

(72) Inventors: Kazuko Asano, Osaka (JP); Yukihiro Oki, Osaka (JP); Nanami Takeda, Osaka (JP); Mitsuhiro Hibino, Kyoto (JP)

(73) Assignee: Panasonic Intellectual Property Management Co., Ltd., Osaka-shi, Osaka (JP)

(21) Appl. No.: 17/800,768

(22) PCT Filed: Feb. 25, 2021
(86) PCT No.: PCT/JP2021/007142

§ 371 Date: Aug. 18, 2022

(30) Foreign Application Priority Data
Feb. 28, 2020 (JP) 2020-033553

(51) Int. Cl. H01M 4/38; H01M 10/0525

(52) U.S. Cl. CPC H01M 4/387; H01M 10/0525; H01M 2004/027

(57) ABSTRACT

The present invention provides a lithium ion battery which comprises a positive electrode having a positive electrode mixture layer that contains a positive electrode active material, and a negative electrode having a negative electrode mixture layer that contains a negative electrode active material, and which is charged and discharged by the movement of lithium ions between the positive electrode and the negative electrode. The negative electrode mixture layer contains a negative electrode active material represented by general formula La3(1-x)M3xNi2(1-y)Me2yX7 (wherein M contains at least one of Ca, Mg and Sr; Me contains at least one of Mn, Co, Cu and Fe; X contains at least one of Ge, Si, Sn and Al; 0.1≤x<0.5; and 0<y≤1).

### TECHNICAL FIELD

The present disclosure generally relates to a lithium-ion battery which comprises a positive electrode having a positive electrode mixture layer including a positive electrode active material, and a negative electrode having a negative electrode mixture layer including a negative electrode active material, and in which charge and discharge are performed by lithium ions moving between the positive electrode and the negative electrode.

### BACKGROUND ART

Lithium-ion batteries in which charge and discharge are performed by lithium ions (Li ions) moving between a negative electrode and a positive electrode are widespread. For a negative electrode active material of a negative electrode mixture layer in this lithium-ion battery, a graphite-based material is commonly used. The graphite-based negative electrode active material may be used with Si, and in this case, change in volume during charge and discharge is large, capacity maintenance characteristics are likely to deteriorate, and the cost is relatively high.

A negative electrode active material that is not graphite-based is also proposed. For example, Patent Literature 1 describes that an alloy having a La₃Co₂Sn₇-type crystalline structure is used as the negative electrode active material.

### CITATION LIST

### Patent Literature

PATENT LITERATURE 1: Japanese Patent No. 4127692

### SUMMARY

A secondary battery using an intermetallic compound having a La₃Ni₂Sn₇-type crystalline structure as the negative electrode active material tends to have a relatively low mass energy density.

A lithium-ion battery according to the present disclosure is a lithium-ion battery which comprises a positive electrode having a positive electrode mixture layer including a positive electrode active material, and a negative electrode having a negative electrode mixture layer including a negative electrode active material, and in which charge and discharge are performed by lithium ions moving between the positive electrode and the negative electrode, wherein the negative electrode mixture layer includes a negative electrode active material represented by the general formula La₃₍₁₋ₓ₎M₃ₓNi_{2(1-y)}Me_{2y}X₇, wherein M includes at least one of the group consisting of Ca, Mg, and Sr; Me includes at least one of the group consisting of Mn, Co, Cu, and Fe; and X includes at least one of the group consisting of Ge, Si, Sn, and Al, and wherein 0.1≤x<0.5 and 0<y≤1.

In the present disclosure, as the negative electrode active material, some La sites in the negative electrode active material represented by the general formula La₃₍₁₋ₓ₎M₃ₓNi_{2(1-y)}Me_{2y}X₇ are substituted with at least one of the group consisting of Ca, Mg, and Sr, and some Ni sites are substituted with at least one of the group consisting of Mn, Co, Cu, and Fe, and thereby the charge and discharge capacities may be increased.

### BRIEF DESCRIPTION OF DRAWINGS

FIG. 1 is a longitudinal sectional view of a cylindrical secondary battery 10 of an example of an embodiment.

FIG. 2 is a graph indicating electrode potentials during charge and discharge in Examples 1 to 5 and Comparative Example 1.

### DESCRIPTION OF EMBODIMENT

Hereinafter, embodiments of the present disclosure will be described based on the drawings. The present disclosure is not limited to the embodiments described herein.

“Negative Electrode Material”

The negative electrode material of a lithium-ion battery is preferably a material satisfying high energy density and low expansion. Various researches and developments are performed, and proposed is use of an intermetallic compound having a La₃Ni₂Sn₇-type crystalline structure as the negative electrode active material. Such an intermetallic compound, which occludes and releases Li with an intercalation reaction, has a low expansion coefficient, and is considered to achieve a longer lifetime.

However, the intermetallic compound having the La₃Ni₂Sn₇-type crystalline structure has a lower mass energy density than a graphite-based material.

In the present disclosure, some La sites of the La sites in the La₃Ni₂Sn₇-type crystalline structure are substituted with at least one of the group consisting of Ca, Mg, and Sr, and some Ni sites are substituted with at least one of the group consisting of Mn, Co, Cu, and Fe. These substitutions easily generate pores, and the increase in sites that can occlude Li is considered to increase the charge and discharge capacities.

“Constitution of Embodiments”

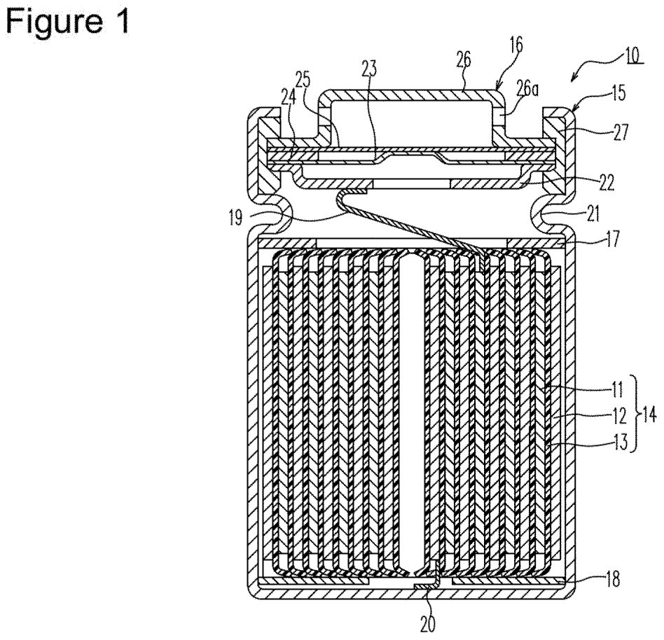

FIG. 1 is a longitudinal sectional view of a cylindrical secondary battery 10 of an example of an embodiment. In the secondary battery 10 illustrated in FIG. 1, an electrode assembly 14 and a non-aqueous electrolyte are housed in an outer housing body 15. The electrode assembly 14 has a wound structure in which a positive electrode 11 and a negative electrode 12 are wound with a separator 13 interposed therebetween. For a non-aqueous solvent of the non-aqueous electrolyte (organic solvent), carbonates, lactones, ethers, ketones, esters, and the like may be used, and two or more of these solvents may be mixed to be used. When two or more solvents are mixed to be used, a mixed solvent including a cyclic carbonate and a chain carbonate is preferably used. For example, ethylene carbonate (EC), propylene carbonate (PC), butylene carbonate (BC), and the like may be used as the cyclic carbonate, and dimethyl carbonate (DMC), ethyl methyl carbonate (EMC), diethyl carbonate (DEC), and the like may be used as the chain carbonate. For an electrolyte salt in the non-aqueous electrolyte, LiPF₆, LiBF₄, LiCF₃SO₃, and the like, and a mixture thereof may be used. An amount of the electrolyte salt dissolved in the non-aqueous solvent may be, for example, 0.5 to 2.0 mol/L. Hereinafter, for convenience of description, the sealing assembly 16 side will be described as “the upper side”, and the bottom side of the outer housing body 15 will be described as “the lower side”.

An opening end of the outer housing body 15 is capped with the sealing assembly 16 to seal inside the secondary battery 10. Insulating plates 17 and 18 are provided on the upper and lower sides of the electrode assembly 14, respectively. A positive electrode lead 19 extends upward through a through hole of the insulating plate 17, and welded to the lower face of a filter 22, which is a bottom plate of the sealing assembly 16. In the secondary battery 10, a cap 26, which is a top plate of the sealing assembly 16 electrically connected to the filter 22, becomes a positive electrode terminal. A negative electrode lead 20 extends through a through hole of the insulating plate 18 toward the bottom side of the outer housing body 15, and welded to a bottom inner face of the outer housing body 15. In the secondary battery 10, the outer housing body 15 becomes a negative electrode terminal. When the negative electrode lead 20 is provided on the terminal end part, the negative electrode lead 20 extends through an outside of the insulating plate 18 toward the bottom side of the outer housing body 15, and welded to the bottom inner face of the outer housing body 15.

The outer housing body 15 is, for example, a bottomed cylindrical metallic outer housing can. A gasket 27 is provided between the outer housing body 15 and the sealing assembly 16 to achieve sealability inside the secondary battery 10. The outer housing body 15 has a grooved part 21 formed by, for example, pressing the side part thereof from the outside to support the sealing assembly 16. The grooved part 21 is preferably formed in a circular shape along a circumferential direction of the outer housing body 15, and supports the sealing assembly 16 with the gasket 27 interposed therebetween and with the upper face of the grooved part 21.

The sealing assembly 16 has the filter 22, a lower vent member 23, an insulating member 24, an upper vent member 25, and the cap 26 which are stacked in this order from the electrode assembly 14 side. Each member constituting the sealing assembly 16 has, for example, a disk shape or a ring shape, and each member except for the insulating member 24 is electrically connected each other. The lower vent member 23 and the upper vent member 25 are connected each other at each of central parts thereof, and the insulating member 24 is interposed between each of the circumferential parts of the vent members 23 and 25. If the internal pressure of the battery increases due to abnormal heat generation, for example, the lower vent member 23 breaks and thereby the upper vent member 25 expands toward the cap 26 side to be separated from the lower vent member 23, resulting in cutting off of an electrical connection between both the members. If the internal pressure further increases, the upper vent member 25 breaks, and gas is discharged through an opening 26a of the cap 26.

Hereinafter, the positive electrode 11, negative electrode 12, and separator 13, which constitute the electrode assembly 14, particularly the negative electrode active material constituting the negative electrode 12 will be described.

[Positive Electrode]

The positive electrode 11 has a positive electrode core and a positive electrode mixture layer provided on a surface of the positive electrode core. For the positive electrode core, a foil of a metal stable within a potential range of the positive electrode 11, such as aluminum, a film in which such a metal is disposed on a surface layer thereof, and the like may be used. A thickness of the positive electrode core is, for example, 10 μm to 30 μm. The positive electrode mixture layer includes a positive electrode active material, a binder, and a conductive agent, and is preferably provided on both surfaces of the positive electrode core except for a portion to which the positive electrode lead 19 is connected. The positive electrode 11 may be produced by, for example, applying a positive electrode mixture slurry including the positive electrode active material, the binder, the conductive agent, and the like on the surface of the positive electrode core, drying and subsequently compressing the applied film to form the positive electrode mixture layer on both the surfaces of the positive electrode core.

The positive electrode active material includes a lithium-transition metal oxide as a main component. The positive electrode active material may be constituted of substantially only the lithium-transition metal oxide, and particles of an inorganic compound, such as aluminum oxide and a lanthanoid-containing compound, may be adhered to a particle surface of the lithium-transition metal oxide. The lithium-transition metal oxide may be used singly, or may be used in combination of two or more thereof.

Examples of a metal element contained in the lithium-transition metal oxide include nickel (Ni), cobalt (Co), manganese (Mn), aluminum (Al), boron (B), magnesium (Mg), titanium (Ti), vanadium (V), chromium (Cr), iron (Fe), copper (Cu), zinc (Zn), gallium (Ga), strontium (Sr), zirconium (Zr), niobium (Nb), indium (In), tin (Sn), tantalum (Ta), and tungsten (W). A preferable example of the lithium-transition metal oxide is a composite oxide represented by the general formula: Li_{α}NiₓM₍₁₋ₓ₎O₂ (0.1≤α≤1.2, 0.3≤x<1, and M includes at least one of the group consisting of Co, Mn, and Al). For the positive electrode material, NCA in which some nickel is substituted with cobalt and an aluminum is added, and the like is used, for example.

Examples of the conductive agent included in the positive electrode mixture layer may include a carbon material such as carbon black, acetylene black, Ketjenblack, carbon nanotube, carbon nanofiber, and graphite. Examples of the binder included in the positive electrode mixture layer may include a fluororesin such as polytetrafluoroethylene (PTFE) and polyvinylidene fluoride (PVDF), polyacrylonitrile (PAN), a polyimide resin, an acrylic resin, and a polyolefin resin. With these resins, cellulose derivatives such as carboxymethyl cellulose (CMC) or a salt thereof, polyethylene oxide (PEO), and the like may be used in combination.

[Negative Electrode]

The negative electrode 12 has a negative electrode core and a negative electrode mixture layer provided on a surface of the negative electrode core. For the negative electrode core, a foil of a metal stable within a potential range of the negative electrode 12, such as copper, a film in which such a metal is disposed on a surface layer thereof, and the like may be used. A thickness of the negative electrode core is, for example, 5 μm to 15 μm. The negative electrode mixture layer includes a negative electrode active material and a binder, and is preferably provided on, for example, both surfaces of the negative electrode core except for a portion to which the negative electrode lead 20 is connected. The negative electrode 12 may be produced by, for example, applying a negative electrode mixture slurry including the negative electrode active material, the binder, and the like on the surface of the negative electrode core, drying and subsequently compressing the applied film to form the negative electrode mixture layer on both the surfaces of the negative electrode core. A conductive agent may be added into the negative electrode mixture slurry. The conductive agent may uniform a conductive path. The negative electrode mixture layer may include a conductive agent such as acetylene black similar to that in the positive electrode mixture layer.

The negative electrode mixture layer includes, as the negative electrode active material, a negative electrode active material represented by the general formula La₃₍₁₋ₓ₎M₃ₓNi_{2(1-y)}Me_{2y}X₇, wherein M includes at least one of the group consisting of La, Ca, Mg, and Sr; Me includes at least one of the group consisting of Mn, Co, Cu, and Fe; and X includes at least one of the group consisting of Ge, Si, Sn, and Al.

A particle diameter of La₃₍₁₋ₓ₎M₃ₓNi_{2(1-y)}Me_{2y}X₇, which is the negative electrode active material, is preferably 1 to 30 μm, more preferably 2 to 20 μm, and particularly preferably 2 to 10 μm. An excessively larger particle diameter of the negative electrode active material lowers reactivity with Li, and decreases a contacting area between the particles to increase the resistance. Meanwhile, an excessively smaller particle diameter is presumed to lower a filling density of the negative electrode active material to decrease the capacity. An average particle diameter of the negative electrode active material is, for example, 3 to 15 μm or 5 to 10 μm. The particle diameter of the negative electrode active material is measured as a diameter of a circumscribed circle of the negative electrode active material particle in a cross-sectional image of the negative electrode mixture layer observed with a scanning electron microscope (SEM). The average particle diameter is calculated by averaging particle diameters of random 100 particles.

The intermetallic compound represented by La₃₍₁₋ₓ₎M₃ₓNi_{2(1-y)}Me_{2y}X₇ may be formed by ark melting, and annealing is preferably performed after the ark melting.

Substitution rates of La and Ni are preferably 0.1≤x<0.5 and 0<y≤1. It is presumed that a lower substitution rate exhibits lower effect, and a higher substitution rate generates impurities to increase irreversible capacity due to an alloying reaction. La is preferably substituted with Ca, and Ni is preferably substituted with Mn. X using Sn gives a good result.

The negative electrode active material includes La₃₍₁₋ₓ₎M₃ₓNi_{2(1-y)}Me_{2y}X₇ as a main component (component having the highest mass ratio), and may be composed of substantially only La₃₍₁₋ₓ₎M₃ₓNi_{2(1-y)}Me_{2y}X₇. Meanwhile, for the negative electrode active material, another active material such as a metal compound other than La₃₍₁₋ₓ₎M₃ₓNi_{2(1-y)}Me_{2y}X₇, a carbon-based active material such as graphite, or Si-based active material containing Si may be used in combination. When graphite is used in combination, a content of the graphite may be, for example, 50 to 90 mass % based on a mass of the negative electrode active material.

Although various material may be used for the binder included in the negative electrode mixture layer, a compound containing a cyano group is used, for example. When the above La₃₍₁₋ₓ₎M₃ₓNi_{2(1-y)}Me_{2y}X₇ is used for the negative electrode active material, using a commonly used binder such as polyvinylidene fluoride (PVDF) is likely to gel the negative electrode mixture slurry to cause difficulty in the application of the slurry. Meanwhile, using the binder containing a cyano group improves dispersibility of the negative electrode active material to inhibit the gelation of the slurry.

Specific examples of the binder containing a cyano group include polyacrylonitrile (PAN), polymethacrylonitrile, poly-α-chloroacrylonitrile, and poly-α-ethylacrylonitrile. Among them, PAN or polymethacrylonitrile is preferable, and PAN is particularly preferable.

Here, the binder containing a cyano group, which is a solvent system, requires using a solvent for application. With a requirement for using an aqueous binder, carboxymethyl cellulose (CMC) and the like may be used, for example. Ammonium carboxymethyl cellulose (NH₄-CMC) is particularly preferable, and is preferably used in combination with SBR.

A mass ratio of the binder in the negative electrode mixture layer is preferably approximately 0.5 mass % to 7.0 mass %.

[Separator]

For the separator 13, a porous sheet having an ion permeation property and an insulation property is used. Specific examples of the porous sheet include a fine porous film, a woven fabric, and a nonwoven fabric. A preferable material of the separator 13 is polyolefin resins such as polyethylene and polypropylene, cellulose, and the like. The separator 13 may have any of a single-layered structure and a multilayered structure. On a surface of the separator 13, a heat-resistant layer including a heat-resistant material may be formed. Examples of the heat-resistant material may include polyamide resins such as an aliphatic polyamide and an aromatic polyamide (aramid), and polyimide resins such as a polyamideimide and a polyimide.

### EXAMPLES

The present disclosure will be further described below with Examples, but the present disclosure is not limited to these Examples.

[Production of Negative Electrode]

An intermetallic compound (La₃₍₁₋ₓ₎M₃ₓNi_{2(1-y)}Me_{2y}X₇) having a La₂Ni₂Sn₇-type crystalline structure and a particle diameter of 2 to 20 μm was used as a negative electrode active material, NH₄-CMC and SBR (referred to as CMC/SBR) were used as binders, and artificial graphite powders were used as a conductive agent. The negative electrode active material, the binders, and the conductive agent were mixed at a mass ratio of 85.5:3:1.5:10, and N-methyl-2-pyrrolidone (NMP) was used as a dispersion medium to prepare a negative electrode mixture slurry. Then, the negative electrode mixture slurry was applied on a negative electrode core composed of a copper foil, the applied film was dried and compressed, and then cut to a predetermined electrode size to obtain a negative electrode.

[Production of Test Cell]

The above negative electrode and a positive electrode composed of a lithium metal foil were disposed opposite to each other with a separator interposed therebetween to constitute an electrode assembly, and the electrode assembly was housed in a coin-shaped outer housing can. A predetermined non-aqueous electrolyte liquid was injected into the outer housing can, and then the outer housing can was sealed to obtain a coin-shaped test cell (non-aqueous electrolyte secondary battery).

[Charge-Discharge Test]

The obtained test cell was charged and discharged at a constant current under an environment at normal temperature to determine a positive-negative electrodes potential (V (vs. Li/Li⁺)) and charge and discharge capacities.

### Comparative Example 1

La₂Ni₂Sn₇ was used as the negative electrode active material.

### Comparative Example 2

La_{1.8}Ca_{0.2}Ni₂Sn₇ was used as the negative electrode active material.

### Example 1

La_{1.8}Ca_{0.2}Ni_{1.8}Mn_{0.2}Sn₇ was used as the negative electrode active material.

### Example 2

La_{1.8}Ca_{0.2}Ni_{1.8}Fe_{0.2}Sn₇ was used as the negative electrode active material.

### Example 3

La_{1.8}Ca_{0.2}Ni_{1.8}Co_{0.2}Sn₇ was used as the negative electrode active material.

### Example 4

La_{1.8}Ca_{0.2}Ni_{1.8}Cu_{0.2}Sn₇ was used as the negative electrode active material.

### Comparative Examples 3 to 6

In Comparative Examples 3 to 6, La₃₍₁₋ₓ₎Ca₃ₓNi₂Sn₇ was used, and the Ca substitution rate, x, was changed to investigate an effect of the Ca substitution. Specifically, Comparative Example 3 had a Ca substitution amount of 0%, Comparative Example 4 had a Ca substitution amount of 10%, Comparative Example 5 had a Ca substitution amount of 40%, and Comparative Example 6 had a Ca substitution amount of 50%.

“Results”

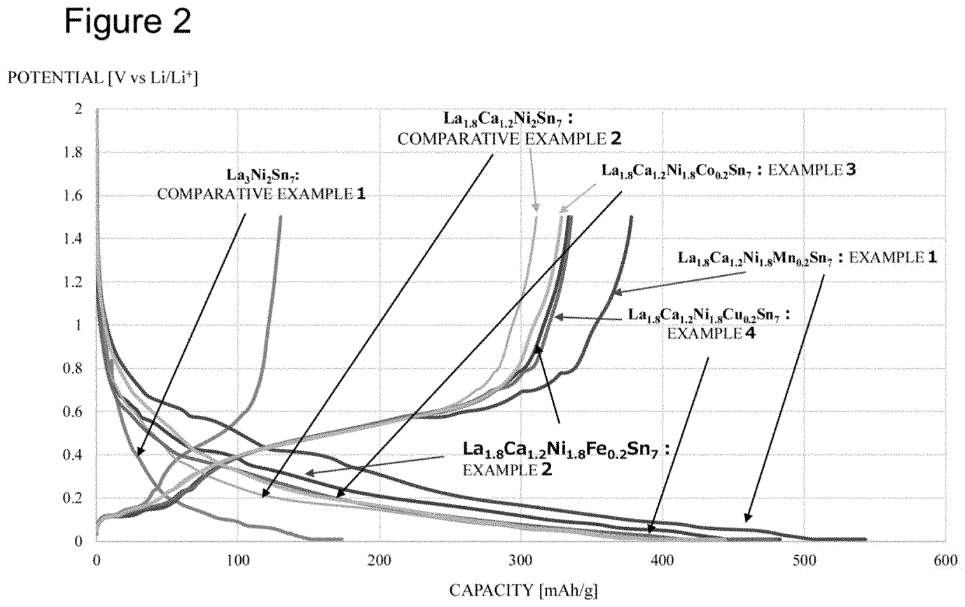

FIG. 2 is a graph indicating the positive-negative electrodes potentials in the charge-discharge test in Examples 1 to 4 and Comparative Examples 1 to 2, and Table 1 shows the charge and discharge capacities thereof.

TABLE 1

| | | Charge | Discharge |
|---|---|---|---|
| | Me substitution | capacity | capacity |
| | composition at Ni site | (mAh/g) | (mAh/g) |
| Comparative | Ref. La₃—Ni₂—Sn₇ | 173 | 129 |
| Example 1 | | | |
| Comparative | La_{1.8}—Ca_{1.2}—Ni₂—Sn₇ | 418 | 311 |
| Example 2 | | | |
| Example 1 | La_{1.8}—Ca_{1.2}—Ni_{1.8}—Mn_{0.2}—Sn₇ | 543 | 378 |
| Example 2 | La_{1.8}—Ca_{1.2}—Ni_{1.8}—Fe_{0.2}—Sn₇ | 482 | 333 |
| Example 3 | La_{1.8}—Ca_{1.2}—Ni_{1.8}—Co_{0.2}—Sn₇ | 443 | 328 |
| Example 4 | La_{1.8}—Ca_{1.2}—Ni_{1.8}—Cu_{0.2}—Sn₇ | 480 | 335 |

In Examples 1 to 4, the charge and discharge capacities are found to largely increase (twice or more) compared with Comparative Example 1. In Comparative Example 2, the charge and discharge capacities are larger than Comparative Example 1, but the capacities are smaller than Examples 1 to 4. In addition, the test cell in which the Ni site in Example 1 is substituted with Mn is found to have particularly large capacities. As above, the substitution of the Ni site with another 3d metal element in addition to the substitution of the La site are found to improve the Li storage amount and increase the charge and discharge capacities.

Table 2 shows a first discharge capacity and an efficiency in Comparative Examples 3 to 6. The efficiency is a value of the first discharge capacity divided by a first charge capacity.

TABLE 2

| | Ca | First discharge | |
|---|---|---|---|
| | substitution | capacity | |
| | amount | (mAh/g) | Efficiency |
| Comparative Example 3 | 0% | 85 | 63% |
| Comparative Example 4 | 10% | 145 | 74% |
| Comparative Example 5 | 40% | 223 | 74% |
| Comparative Example 6 | 50% | 205 | 46% |

As above, the substitution of La with Ca is found to increase the charge and discharge capacities. In particular, the Ca substitution of 10% to 40% increases the charge and discharge capacities, and that of 50% decreases the charge and discharge capacities.

### REFERENCE SINGS LIST

10 Secondary battery
11 Positive electrode
12 Negative electrode
13 Separator
14 Electrode assembly
15 Outer housing body
16 Sealing assembly
17, 18 Insulating plate
19 Positive electrode lead
20 Negative electrode lead
21 Grooved part
22 Filter
23 Lower vent member
24 Insulating member
25 Upper vent member
26 Cap
26a Opening
27 Gasket

1. A lithium-ion battery, which comprises a positive electrode having a positive electrode mixture layer including a positive electrode active material, and a negative electrode having a negative electrode mixture layer including a negative electrode active material, and in which charge and discharge are performed by lithium ions moving between the positive electrode and the negative electrode, wherein
the negative electrode mixture layer includes a negative electrode active material represented by the general formula La₃₍₁₋ₓ₎M₃ₓNi_{2(1-y)}Me_{2y}X₇, wherein M includes at least one of the group consisting of Ca, Mg, and Sr; Me includes at least one of the group consisting of Mn, Co, Cu, and Fe; and X includes at least one of the group consisting of Ge, Si, Sn, and Al, and wherein 0.1≤x<0.5, and 0<y≤1.

2. The lithium-ion battery according to claim 1, wherein the negative electrode active material is represented by the general formula La₃₍₁₋ₓ₎Ca₃ₓNi_{2(1-y)}Me_{2y}Sn₇, wherein Me includes at least one of the group consisting of Mn, Co, Cu, and Fe.
